(19) United States
(12) Patent Application Publication
(10) Pub. No.: US 2008/0307566 A1
(43) Pub. Date: Dec. 18, 2008

(54) PRODUCT HAVING FILLERS THEREIN

(76) Inventor: Patrick Yeh, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/762,733

(22) Filed: Jun. 13, 2007

(51) Int. Cl. A41D 27/24; A41D 1/00; B32B 5/02

(52) U.S. Cl. 2/275; 2/93; 428/74

(57) ABSTRACT

A product having fillers therein is provided, which includes two outer shells, at least one connecting member, and fillers. The connecting member has two connecting portions fixed to each other. The connecting portions are adhered to the outer shells respectively to form a plurality of compartments between the outer shells. The fillers are filled in the compartments. During fabricating the compartments, a hot press is performed at a time to form all of the compartments for saving time and cost. In addition, no needle holes similar to those formed by stitches are formed on the two outer shells, and thus the pieces of the fillers may be prevented from escaping out of the outer shells.

### BACKGROUND OF THE INVENTION

1. Field of the Invention

The present invention relates to a product. More particularly, the present invention relates to a product having fillers therein, capable of being quickly fabricated, and having a favorable tensile strength.

2. Description of Related Art

Down coat is favored by consumers because of its light weight and heat retention characteristics. In order to prevent all the downs filled in the down coat from being accumulated at the bottom of the down coat due to the gravity, a plurality of compartments must be made on the down coat through machine sewing, so as to make the down filled in the down coat be uniformly distribute in each part of the down coat. However, the conventional down coat and similar products having down filled therein have a common disadvantage, that is, all the compartments must be finished through machine sewing one by one. The fabricating process is not only time consuming but also has a high cost. Furthermore, it is impossible to effectively improve the capacity of the factory, and the cracked slight down may be escaped via the needle holes formed while making the compartments through the machine sewing. The downs escaping from the needle holes may be adhered on other clothes, affect the appearance, and even become an allergen, and thus causing asthma or various respiratory symptoms to those respiratory sensitive people. Therefore, many people reject wearing the down coat or using the down products, for example, down quilt. In this case, the structure of the conventional down coat and down products must be improved, so as to satisfy the requirement of the special consumers.

### SUMMARY OF THE INVENTION

Accordingly, the present invention is directed to a product having fillers therein, capable of saving the time for fabricating the product to lower the cost.

The present invention is directed to a product having fillers therein, capable of preventing pieces of the fillers from escaping.

As embodied and broadly described herein, the present invention provides a product having fillers therein, which includes two outer shells, at least one connecting member, and fillers. The connecting member has two connecting portions fixed to each other. The connecting portions are respectively adhered to the outer shells, so as to form a plurality of compartments between the outer shells. The fillers are filled in the compartments.

In an embodiment of the present invention, the connecting member further includes a central portion, and the connecting portions are respectively fixed on two ends of the central portion, such that the connecting portions are fixed to each other through the central portion.

In the present invention, when a plurality of compartments is formed in the space between the two outer shells through the connecting member, a hot press is performed to form all the compartments at a time for saving time and cost. In addition, no needle holes are formed, and thus the pieces of the fillers can be prevented from escaping out of the outer shells.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A shows a product having fillers therein according to an embodiment of the present invention.

FIG. 1B is an enlarged diagram of Region P of FIG. A.

FIG. 2A shows a product having fillers therein according to another embodiment of the present invention.

FIG. 2B is an enlarged diagram of Region Q of FIG. 2A.

FIG. 3A shows a product having fillers therein according to still another embodiment of the present invention.

FIG. 3B is an enlarged diagram of Region R of FIG. 3A.

FIG. 4A shows a product having fillers therein according to yet another embodiment of the present invention.

FIG. 4B is an enlarged diagram of Region S of FIG. 4A.

FIGS. 5A to 5F show a fabricating process of adhering connecting portions of FIG. 4B to outer shells.

FIG. 6A shows a product having fillers therein according to yet another embodiment of the present invention.

FIG. 6B is an enlarged diagram of Region T of FIG. 6A.

FIG. 7 shows a product having fillers therein according to yet another embodiment of the present invention.

FIG. 8A shows a product having fillers therein according to yet another embodiment of the present invention.

FIG. 8B is a partially enlarged diagram of a plurality of connecting members of FIG. 8A.

### DESCRIPTION OF EMBODIMENTS

In the following embodiments, the same numbers will be used throughout the drawings to refer to the same or like elements.

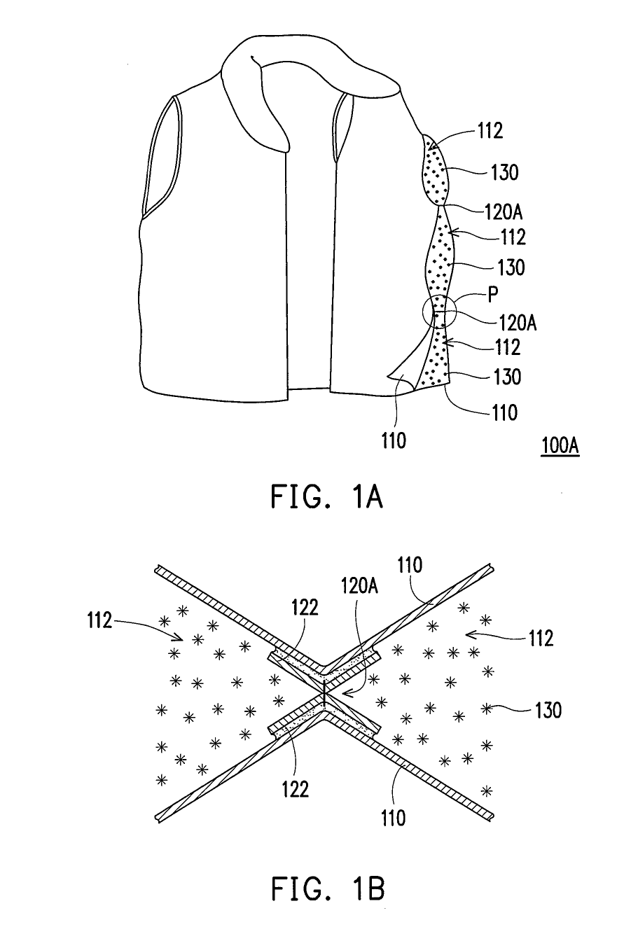

Referring to FIGS. 1A and 1B, a product 100A in another embodiment of the present invention includes two outer shells 110 disposed opposite to each other. The material of the outer shells 110 can include fabric, non-woven, plastic film, or a mixture of any two or three of the above materials.

The product 100A further includes a plurality of connecting members 120A. Each connecting member 120A has two connecting portions 122 fixed to each other and adhered to the outer shells 110 respectively, so as to form a plurality of compartments 112 between the outer shells 110. The compartments 112 can be individually independent or mutually connected. In this embodiment, the connecting portions 122 can be adhered to the outer shells 110 through a resin or a hot melt adhesive.

In this embodiment, each connecting member 120A can include two strips fixed to each other, so as to constitute the connecting portions 122, in which the upper one of the strips constitutes one of the connecting portions 122, and the lower one of the strips constitutes the other one of the connecting portions 122. In addition, the strips are stitched with each other, but in another embodiment (not shown), the strips can also be adhered or welded with each other. In addition, the material of one of the strips 122 can include fabric, non-woven, or plastic film.

The product 100A further includes fillers 130 filled in the compartments 112. The material of the fillers 130 can be down, resin fiber, or other materials with heat retention characteristics.

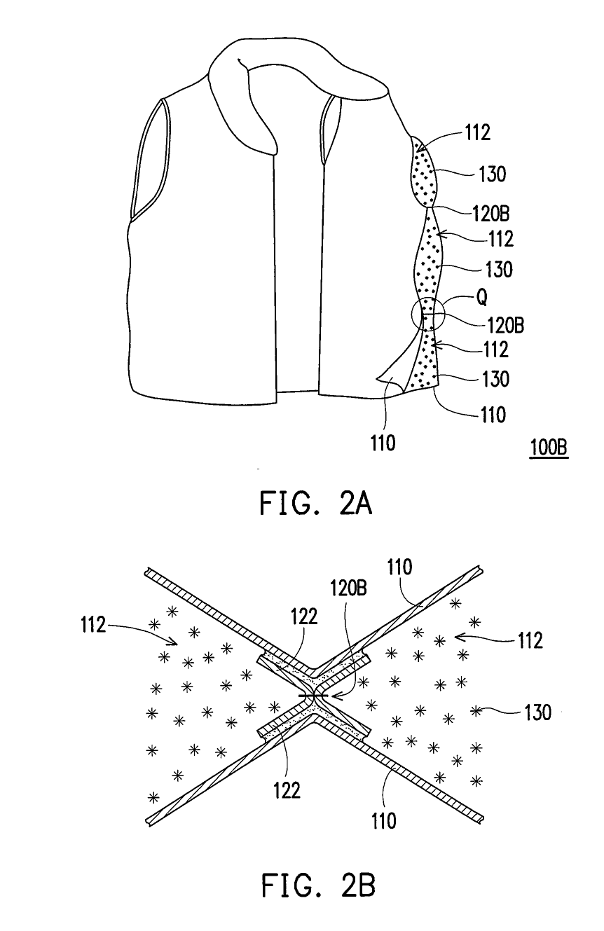

Referring to FIGS. 2A and 2B, a product 100B in still another embodiment of the present invention includes two outer shells 110 disposed opposite to each other. The material of the outer shells 110 can include fabric, non-woven, plastic film, or a mixture of any two or three of the above materials.

The product 100B further includes a plurality of connecting members 120B. Each connecting member 120B has two connecting portions 122 fixed to each other and respectively adhered to the outer shells 110, so as to form a plurality of compartments 112 between the outer shells 110. The compartments 112 can be individually independent or mutually connected. In this embodiment, the connecting portions 122 can be adhered to the outer shells 110 through a resin or a hot melt adhesive.

In this embodiment, each connecting member 120B includes two strips fixed to each other, so as to constitute the connecting portions 122, in which the upper portions of the strips constitutes one of the connecting portions 122, and the lower portions of the strips constitutes the other one of the connecting portions 122. In addition, the strips are stitched with each other, but in another embodiment (not shown), the strips can also be adhered or welded with each other. In addition, the connecting portions 122 are adhered to the outer shells 110 through a resin or a hot melt adhesive. In addition, the material of one of the strips 122 can include fabric, non-woven, or plastic film.

The product 100B further includes fillers 130 filled in the compartments 112. The material of the fillers 130 can be down, resin fiber, or other materials with heat retention characteristics.

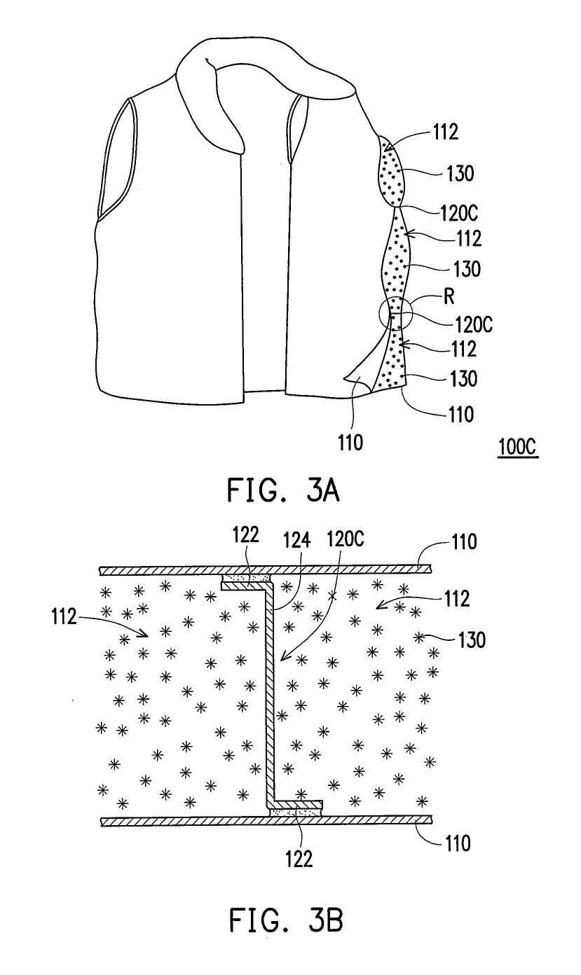

Referring to FIGS. 3A and 3B, a product 100C in yet another embodiment of the present invention includes two outer shells 110 disposed opposite to each other. The material of the outer shells 110 can include fabric, non-woven, plastic film, or a mixture of any two or three of the above materials.

The product 100C further includes a plurality of connecting members 120C. Each connecting member 120C has two connecting portions 122 fixed to each other and respectively adhered to the outer shells 110, so as to form a plurality of compartments 112 between the outer shells 110. The compartments 112 can be individually independent or mutually connected. In this embodiment, the connecting portions 122 can be adhered to the outer shells 110 through a resin or a hot melt adhesive.

Each connecting member 120C further has a central portion 124, in which the connecting portions 122 are respectively fixed on two ends of the central portion 124, such that the connecting portions 122 are fixed to each other through the central portion 124.

In this embodiment, the connecting member 120C is a single strip, and the material of the single strip can include fabric, non-woven, or plastic film. The single strip has a central segment, a first connecting segment located on one end of the central segment and a second connecting segment located on the other end of the central segment, the central segment constitutes the central portion 124. The first connecting segment is bent and fixed on the end of the central segment to constitute one of the connecting portions 122, and the second connecting segment is bent and fixed on the other end of the central segment to constitute the other of the connecting portions 122.

In this embodiment, the connecting portions 122 face two opposite sides of the central portion 124, such that the section of the connecting member 120 is “Z”-shaped. However, in another embodiment (not shown), the connecting portions 122 can also face the same side of the central portion, such that the section of the connecting member 120 is “[”-shape.

The product 100C further includes fillers 130 filled in the compartments 112. The material of the fillers 130 can be down, resin fiber, or other materials with heat retention characteristics.

In another embodiment of the invention not shown but similar to the embodiment in FIG. 3B, the connecting member 120C may lack the central portion 124, while the connecting portions 122 of the connecting member 120C are directly connected with each other and formed integrally by a single strip.

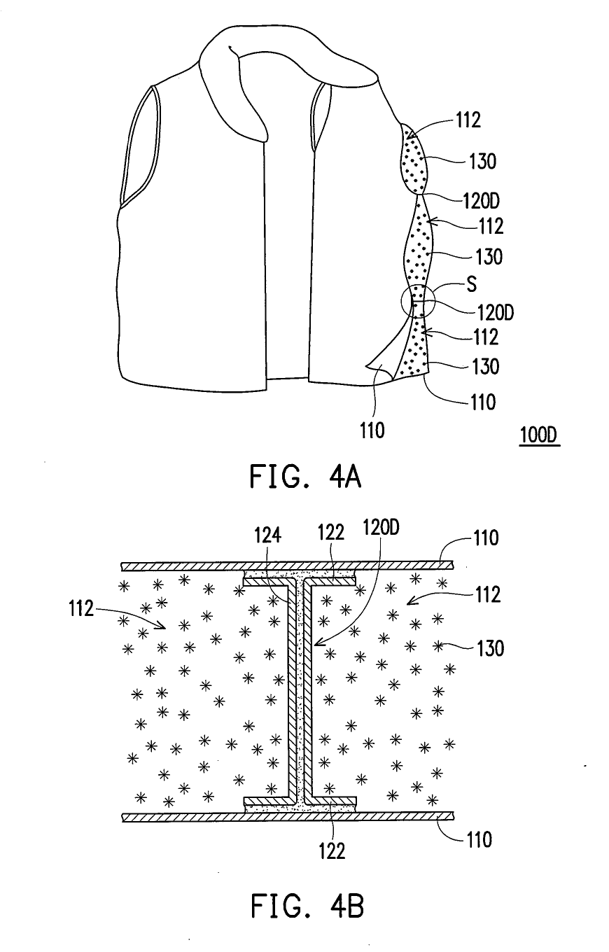

Referring to FIGS. 4A and 4B, a product 100D in yet another embodiment of the present invention includes two outer shells 110 disposed opposite to each other. The material of the outer shells 110 can include fabric, non-woven, plastic film, or a mixture of any two or three of the above materials.

The product 100D further includes a plurality of connecting members 120D. Each connecting member 120D has two connecting portions 122 fixed to each other and respectively adhered to the outer shells 110, so as to form a plurality of compartments 112 between the outer shells 110. The compartments 112 can be individually independent or mutually communicated. In this embodiment, the connecting portions 122 can be adhered to the outer shells 110 through a resin or a hot melt adhesive.

Each connecting member 120D further has a central portion 124, in which the connecting portions 122 are respectively fixed on two ends of the central portion 124, such that the connecting portions 122 are fixed to each other through the central portion 124.

In this embodiment, the connecting member 120D is formed by two strips fixed to each other, and the material of one of the strips can include fabric, non-woven, or plastic film. Each of the strips has a central segment, a first connecting segment located on one end of the central segment and a second connecting segment located on the other end of the central segment. The central segments are fixed to each other to constitute the central portion 124. The first connecting segments constitute one of the connecting portions 122 together, and the second connecting segments constitute the other one of the connecting portions 122 together. The central segments may be stitched, adhered, or welded with each other. In addition, the central segments are stitched with each other, but in another embodiment (not shown), the central segments can be adhered or welded with each other.

It should be noted that, the region for the connecting portions 122 to be adhered to the outer shells 110 crosses the two sides of the central portion 124, so once one of the outer shells 110 is stretched, one end of the connecting member 120 is changed from T shape to Y shape, and accordingly all the regions of the connecting portion 122 adhered to the outer shells 110 can provide the tensile-resistance force, and thus improving the tensile strength of the product 100D.

The product 100D further includes fillers 130 filled in the compartments 112. The material of the fillers 130 can be down, resin fiber, or other materials with heat retention characteristics.

How to fabricate and to install the connecting member 120D of FIG. 4B to the outer shells 110 is illustrated below.

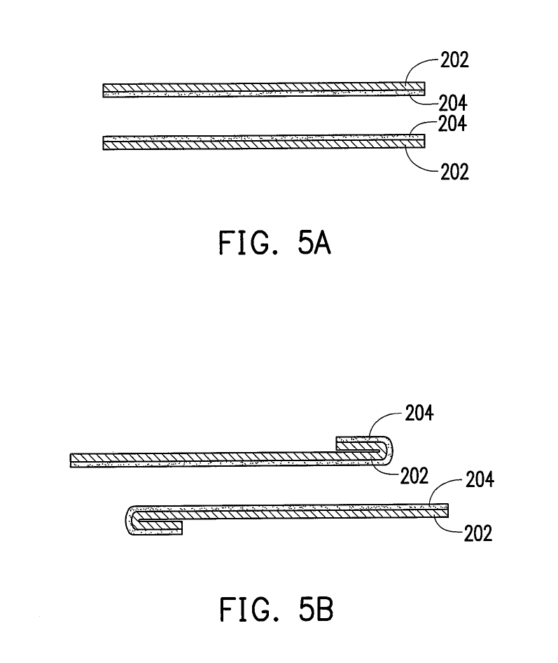

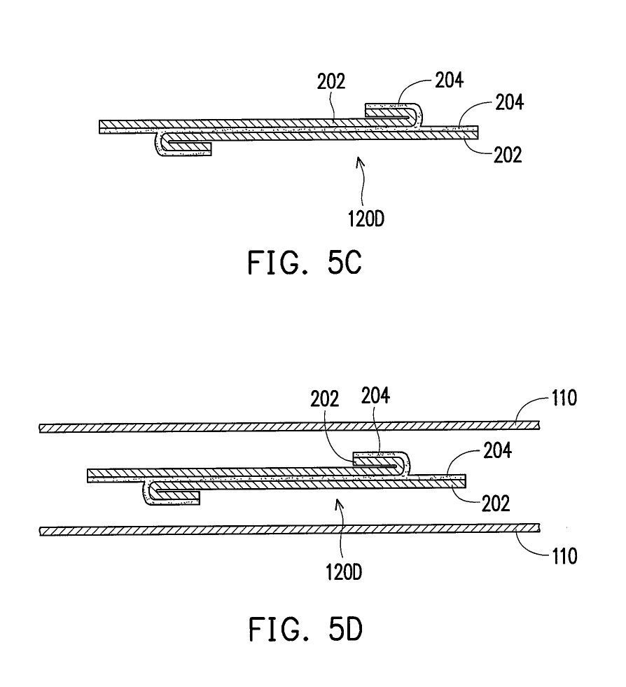

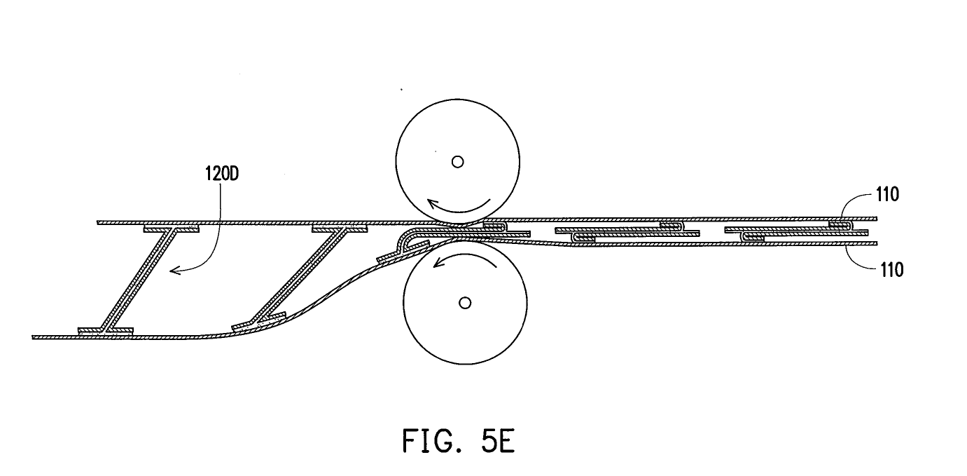

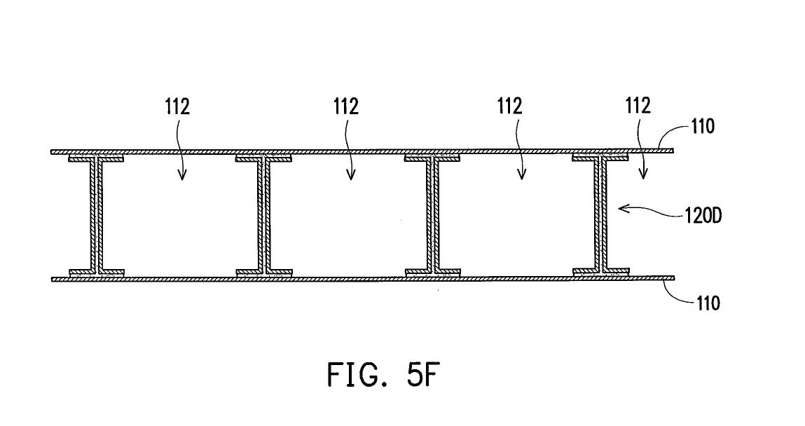

As shown in FIG. 5A, a hot melt adhesive layer 204 is respectively formed on the two strips 202. Next, as shown in FIG. 5B, one end segment of the strip 202 and the other end segment of the other strip 202 are bent. Then, as shown in FIG. 5C, the two strips 202 are overlapped, and then they are fixed by means of heating the hot melt adhesive layers 204. Portions of the hot melt adhesive layer 204 located on the end segments of the strips 202 are still exposed.

Till now, the strips 202 constitute the connecting member 120D of FIG. 4B, the central segments of the strips 202 are adhered to constitute the central portion 124 of FIG. 4B, and the end segments of the strips 202 constitute the connecting portions 122 of FIG. 4B.

Next, as shown in FIG. 5D, the outer shells 110 and the strips 202 are aligned with each other. Then, as shown in FIG. 5E, a roller is used to apply heat energy and pressure to the outer shells 110 and the strips 202, and the end segments of the strips 202 are respectively adhered to the outer shells 110 by means of heating the hot melt adhesive layers 204 partially located on the end segments of the strips 202 for forming the connecting members 120D. Finally, as shown in FIG. 5F, the connecting members 120D form a plurality of compartments 112 between the outer shells 110.

In another embodiment (not shown), the hot melt adhesive layer 204 can also be replaced by a resin layer.

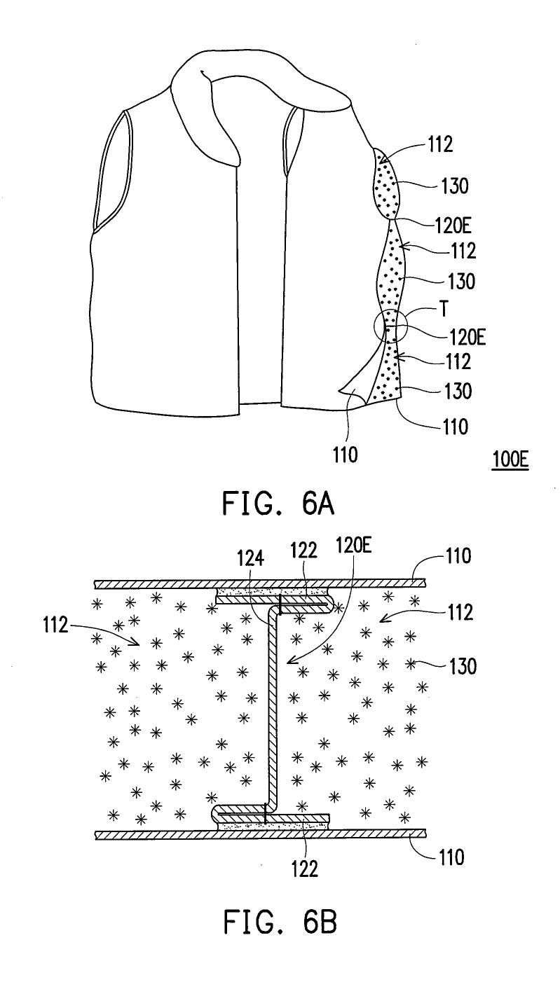

Referring to FIGS. 6A and 6B, a product 100E in yet another embodiment of the present invention includes two outer shells 110 disposed opposite to each other. The material of the outer shells 110 can include fabric, non-woven, plastic film, or a mixture of any two or three of the above materials.

The product 100E further includes a plurality of connecting members 120E. Each connecting member 120E has two connecting portions 122 fixed to each other and respectively adhered to the outer shells 110, so as to form a plurality of compartments 112 between the outer shells 110. The compartments 112 can be individually independent or mutually communicated. In this embodiment, the connecting portions 122 can be adhered to the outer shells 110 through a resin or a hot melt adhesive.

Each connecting member 120E further has a central portion 124, in which the connecting portions 122 are respectively fixed on two ends of the central portion 124, such that the connecting portions 122 are fixed to each other through the central portion 124.

In this embodiment, the connecting member 120E is a single strip, and the material of the single strip can include fabric, non-woven, or plastic film. The single strip has a central segment, a first connecting segment located on one end of the central segment and a second connecting segment located on the other end of the central segment, the central segment constitutes the central portion 124, the first connecting segment is bent and fixed on the end of the central segment to constitute one of the connecting portions 122, and the second connecting segment is bent and fixed on the other end of the central segment to constitute the other of the connecting portions 122. In addition, the central segment and the connecting segments of the single strip are stitched with each other, but in another embodiment (not shown), the central segment and the connecting segments of the single strip can be adhered or welded with each other.

The product 100E further includes fillers 130 filled in the compartments 112. The material of the fillers 130 can be down, resin fiber, or other materials with heat retention characteristics.

In another embodiment of the invention not shown but similar to the embodiment in FIG. 6B, the connecting portions 122 and the central portion 124 may be independently fabricated by three strips, and then the connecting portions 122 are fixed to both sides of the central portion 124 respectively. The connecting potions 122 may be adhered, stitched, or welded to both sides of the central portion 124 respectively.

In the above embodiments, a down vest is taken as an example, but the product having fillers therein of the present invention also includes coats, trousers, caps, sleeping bags, or cushion etc.

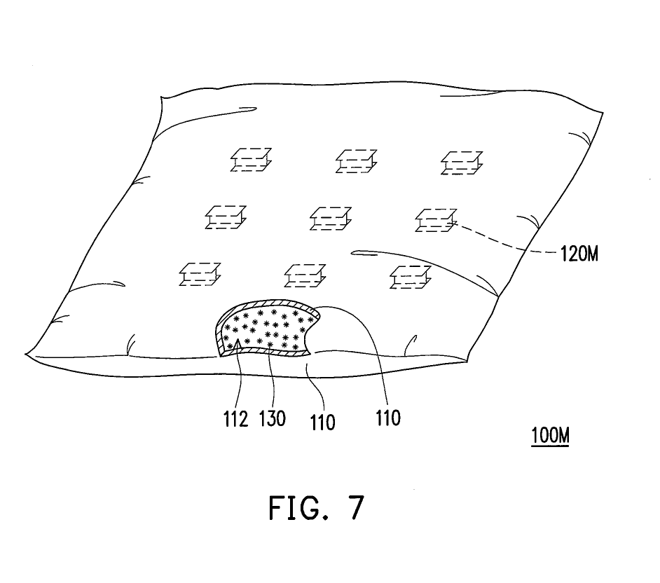

Referring to FIG. 7, a product 100M in yet another embodiment of the present invention includes two outer shells 110 disposed opposite to each other. The material of the outer shells 110 can include fabric, non-woven, plastic film, or a mixture of any two or three of the above materials. The product 100M further includes a plurality of connecting members 120M, so as to form a plurality of compartments 112 between the outer shells 110. The product 100M further includes fillers 130 filled in the compartments 112. The material of the fillers 130 can be down, resin fiber, or other materials with heat retention characteristics.

In this embodiment, the connecting members 120M can adopt the structure of the connecting member 120D of FIG. 4B, or the connecting member 120E of FIG. 6B. In another embodiment (not shown), the connecting members 120M can also adopt the structure of the connecting member 120A of FIG. 1B, the connecting member 120B of FIG. 2B, or the connecting member 120C of FIG. 3B. When the product 100M is applied as a quilt, a suitable amount of connecting members 120M can stabilize the fillers 130 between the two outer shells 110, and thus achieving an effect of dispersing the fillers 130 uniformly. Therefore, the compartments 112 can be mutually communicated.

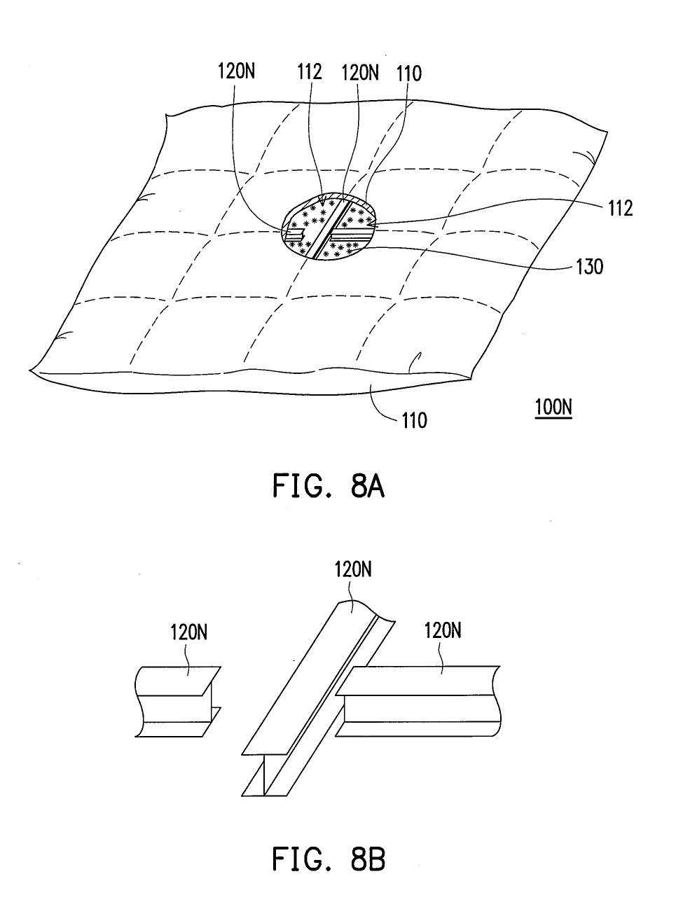

Referring to FIGS. 8A and 8B, a product 100N in still another embodiment of the present invention includes two outer shells 110 disposed opposite to each other. The material of the outer shells 110 can include fabric, non-woven, plastic film, or a mixture of any two or three of the above materials. The product 100N further includes a plurality of connecting members 120N, so as to form a plurality of compartments 112 between the outer shells 110. The product 100N further includes fillers 130 filled in the compartments 112. The material of the fillers 130 can be down, resin fiber, or other materials with heat retention characteristics.

In this embodiment, the connecting members 120N can adopt the structure of the connecting member 120D of FIG. 4B, or the connecting member 120E of FIG. 6B. In another embodiment (not shown), the connecting members 120N can also adopt the structure of the connecting member 120A of FIG. 1B, the connecting member 120B of FIG. 2B, or the connecting member 120C of FIG. 3B.

Different from the connecting members 120M of the embodiment of FIG. 7 distributed in spots, the connecting members 120N of the embodiment of FIG. 8 are distributed as a grid, such that the compartments 112 are individually independent, and can also be mutually communicated through the reserved gaps between the connecting members 120N, so as to inject the fillers 130 therein.

To sum up, in the present invention, two connecting portions of the connecting member are respectively adhered to the two outer shells, so as to form a plurality of compartments in the space between the two outer shells, such that there are no needle holes formed by stitches, and thus the pieces of the fillers may be prevented from escaping out of the outer shells. In addition, in the present invention, the connecting member is installed on the two outer shells by means of adhering, instead of machine sewing, so as to simply the process, to reduce the working time, and to save the cost.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A product, comprising:
two outer shells;
at least one connecting member, having two connecting portions fixed to each other, wherein the connecting portions are respectively adhered to the outer shells to form a plurality of compartments between the outer shells; and
fillers, filled in the compartments.

2. The product as claimed in claim 1, wherein the material of the outer shells comprises fabric, non-woven, plastic film, or a mixture of any two or three of the above materials.

3. The product as claimed in claim 1, wherein one of the connecting portions is adhered to the corresponding outer shell through a hot melt adhesive.

4. The product as claimed in claim 1, wherein one of the connecting portions is adhered to the corresponding outer shell through a resin.

5. The product as claimed in claim 1, wherein the connecting member comprises two strips fixed to each other to serve as the connecting portions.

6. The product as claimed in claim 5, wherein the strips are stitched or welded with each other.

7. The product as claimed in claim 5, wherein the material of one of the strips comprises fabric, non-woven, or plastic film.

8. The product as claimed in claim 1, wherein the connecting member comprises a central portion, and the connecting portions are respectively fixed on two ends of the central portion, such that the connecting portions are fixed to each other through the central portion.

9. The product as claimed in claim 8, wherein the connecting portions and the central portion are integrally formed, and the connecting portions are located on two ends of the central portion.

10. The product as claimed in claim 8, wherein the connecting member is a single strip which has a central segment, a first connecting segment located on one end of the central segment and a second connecting segment located on the other end of the central segment, the central segment constitutes the central portion, the first connecting segment is bent and fixed on the end of the central segment to constitute one of the connecting portions, and the second connecting segment is bent and fixed on the other end of the central segment to constitute the other of the connecting portions.

11. The product as claimed in claim 10, wherein the central segment and one of the connecting segments of the single strip are adhered, stitched, or welded with each other.

12. The product as claimed in claim 10, wherein the material of the strip comprises fabric, non-woven, or plastic film.

13. The product as claimed in claim 8, wherein the connecting member is formed by two strips fixed to each other, each of the strips has a central segment, a first connecting segment located on one end of the central segment and a second connecting segment located on the other end of the central segment, the central segments are fixed to each other to constitute the central portion, the first connecting segments constitute one of the connecting portions together, and the second connecting segments constitute the other one of the connecting portions together.

14. The product as claimed in claim 13, wherein the central segments are stitched, adhered, or welded with each other.

15. The product as claimed in claim 13, wherein the material of one of the strips comprise fabric, non-woven, or plastic film.

16. The product as claimed in claim 8, wherein the connecting member comprises a first strip and at least two second strips, the first strip is served as the central portion, and the second strips are respectively fixed on two ends of the first strip to constitute the connecting portions.

17. The product as claimed in claim 16, wherein one of the second strips is stitched, adhered, or welded to the corresponding end of the first strip.

18. The product as claimed in claim 16, wherein the material of the first strip comprises fabric, non-woven, or plastic film.

19. The product as claimed in claim 16, wherein the material of one of the second strips comprises fabric, non-woven, or plastic film.

20. The product as claimed in claim 1, wherein the connecting member comprises a first strip and a second strip, the first strip has a central segment and a connecting segment located on one end of the central segment to constitute the central portion and one of the connecting portions respectively, and the second strip is fixed on the other end of the central segment to constitute the other of the connecting portions.

21. The product as claimed in claim 20, wherein the second strip is stitched, adhered, or welded to the end of the central segment.

22. The product as claimed in claim 20, wherein the material of the first strip comprises fabric, non-woven, or plastic film.

23. The product as claimed in claim 20, wherein the material of the second strips comprises fabric, non-woven, or plastic film.

24. The product as claimed in claim 1, wherein the compartments are individually independent or mutually communicated.

25. The product as claimed in claim 1, wherein the material of the filler is down, resin fiber, or material with a heat retention characteristic.

26. The product as claimed in claim 1, wherein the product is coat, down vest, trousers, cap, sleeping bag, cushion, or quilt.
